(19) United States
(12) Patent Application Publication
(10) Pub. No.: US 2024/0416729 A1
(43) Pub. Date: Dec. 19, 2024

(54) POP-UP DEPLOYING TYPE DOOR CURTAIN ASSEMBLY FOR VEHICLE

(71) Applicants: Hyundai Motor Company, Seoul (KR); Kia Corporation, Seoul (KR); Ashimori Korea Co., Ltd., Wonju-si (KR)

(72) Inventors: Chan-Seung Kim, Suwon-si (KR); Eun-Pyo Hong, Hwaseong-si (KR); Sung-Ju Lee, Wonju-si (KR)

(21) Appl. No.: 18/491,967

(22) Filed: Oct. 23, 2023

(30) Foreign Application Priority Data
Jun. 19, 2023 (KR) 10-2023-0078297

(51) Int. Cl. B60J 1/20

(52) U.S. Cl. CPC B60J 1/2022; B60J 1/2044; B60J 1/205; B60J 1/2052; B60J 1/2058

(57) ABSTRACT

An embodiment pop-up deploying type door curtain assembly for a vehicle includes a curtain deployable to cover a door glass when drawn out from a vehicle door, a rod configured to be installed on the vehicle door to ascend and descend and configured to support the curtain in a deployed state, a slider fixed to the rod and configured to ascend or descend integrally with the rod, a first drum apparatus configured to elastically support the slider in an ascending direction in order to allow the curtain to be deployed, and a button apparatus configured to limit a deployment of the curtain in a state in which the curtain is accommodated in the vehicle door.

### CROSS-REFERENCE TO RELATED APPLICATIONS

This application claims the benefit of Korean Patent Application No. 10-2023-0078297, filed on Jun. 19, 2023, which application is hereby incorporated herein by reference.

### TECHNICAL FIELD

The present disclosure relates to a door curtain assembly for a vehicle.

### BACKGROUND

A door glass is installed on a door of a vehicle for lighting and ventilation.

In addition, a door curtain (hereinafter referred to as a “curtain”) is installed on the door to selectively cover the door glass for light blocking and privacy protection.

When not in use, the curtain is accommodated inside the door in a wound state, and when in use, the curtain is drawn out from the door and deployed parallel to the door glass.

The curtain is provided with a shade bar at an upper end portion of the curtain to evenly unfold the curtain when the curtain is deployed.

Typically, when the curtain is deployed, the shade bar is fixed to a door frame. To this end, a hook is installed on the door frame to catch and fix the shade bar when the curtain is deployed. After the curtain is deployed, the shade bar is caught and fixed to the hook, and thus the deployed state of the curtain is maintained.

Meanwhile, in recent years, application of a frameless door in which the door frame supporting a circumference of the door glass at an upper portion of the door is removed is expanding.

Due to the non-application of the door frame, the frameless door has a problem in that the curtain cannot be applied to the frameless door because the shade bar cannot be secured to the door when the curtain is deployed.

In addition, even when the door frame is applied, there are problems in that the hook is exposed outside to deteriorate an exterior appearance of the door, and a gap for coupling the shade bar and the hook inevitably occurs between the shade bar and the door frame, which allows light to be transmitted therethrough.

### SUMMARY

The present disclosure relates to a door curtain assembly for a vehicle. Particular embodiments relate to a pop-up deploying type door curtain assembly for a vehicle which is capable of maintaining a deployed state without fixing an upper end portion of a curtain to a door frame, being automatically deployed, and being accommodated manually or in conjunction with a door glass.

An embodiment of the present disclosure provides a pop-up deploying type door curtain assembly for a vehicle, which can maintain a deployed state without an upper end portion of a curtain being coupled to a door frame when the curtain is deployed.

Another embodiment of the present disclosure is directed to providing a pop-up deploying type door curtain assembly for a vehicle, in which the curtain is automatically deployed simply by an operation of a button and is automatically accommodated inside the door in conjunction with a descending operation of a door glass.

Other objects and advantages of embodiments of the present disclosure can be understood by the following description and become apparent with reference to the embodiments of the present disclosure. Also, it is obvious to those skilled in the art to which the present disclosure pertains that the objects and advantages of embodiments of the present disclosure can be realized by the means as claimed and combinations thereof.

In accordance with an embodiment of the present disclosure, there is provided a pop-up deploying type door curtain assembly for a vehicle, which may include a curtain configured to be deployed to cover a door glass when drawn out from a vehicle door, a rod installed on the vehicle door ascendably and descendably and configured to support the curtain in a deployed state, a slider fixed to the rod and configured to ascend or descend integrally with the rod, a first drum unit configured to elastically support the slider in an ascending direction in order to allow the curtain to be deployed, and a button unit configured to limit a deployment of the curtain when the curtain is accommodated in the door.

The pop-up deploying type door curtain assembly may further include a first cable with one end portion fixed to one side of the door, configured to elastically support a lower end portion of the slider, and wound around the first drum unit.

The first drum unit may include a first drum around which the first cable is wound and a first cable spring configured to elastically support the first drum in a direction in which the first cable is wound around the first drum.

The pop-up deploying type door curtain assembly may further include a first pulley provided at a lower portion of the slider and configured to catch the first cable.

The pop-up deploying type door curtain assembly may further include a guide rail with which the slider is slidably assembled and to which one end portion of the first cable is fixed.

The pop-up deploying type door curtain assembly may further include a second cable configured to move the curtain downward in conjunction with a descending operation of the door glass.

The pop-up deploying type door curtain assembly may further include a second drum unit configured to move the slider downward in conjunction with the descending operation of the door glass.

One end portion of the second cable may be connected to a lower portion of the door glass, a predetermined length of the second cable from the other end portion of the second cable may be wound around the second drum unit, and a catch block configured to move the slider downward may be connected to an intermediate portion of the second cable.

A cable slot through which the second cable passes may be formed in the slider, the catch block may be fixed to the second cable to be positioned above the slider, and when the door glass descends, the catch block may descend to move the slider downward.

The second drum unit may include a second drum around which the second cable is wound, and a second cable spring configured to elastically support the second drum in a direction in which the second cable is wound around the second drum.

A cable bracket may be fastened to the lower portion of the door glass, and the second cable may be connected to the cable bracket.

A plurality of pulleys may be provided between the lower portion of the door glass and the second drum unit to catch the second cable so that, when the door glass descends, the second cable may be moved to move the catch block downward.

The button unit may include a button operated by an occupant and a stopper configured to limit ascending operation of the upper end portion of the curtain, and, when the button is operated by the occupant, the stopper may be separated from the upper end portion of the curtain.

The button and the stopper may be slidingly coupled, and a direction change gear configured to slide the stopper in a direction opposite to an operating direction of the button may be installed between the button and the stopper.

The pop-up deploying type door curtain assembly may further include a return spring configured to elastically support the button in order to return the operated button to an initial position.

A shade bar may be installed at the upper end portion of the curtain in a length direction of the vehicle, and a catch hook caught and fixed to the stopper may be formed at the shade bar.

A lower surface of the stopper and an upper surface of the catch hook may each be formed in a flat surface to limit an ascending operation of the catch hook.

An end portion of the stopper and the catch hook may each be formed in a round shape to allow the catch hook to descend.

### BRIEF DESCRIPTION OF THE DRAWINGS

FIG. 1 is a schematic diagram illustrating a pop-up deploying type door curtain assembly for a vehicle according to an embodiment of the present disclosure.

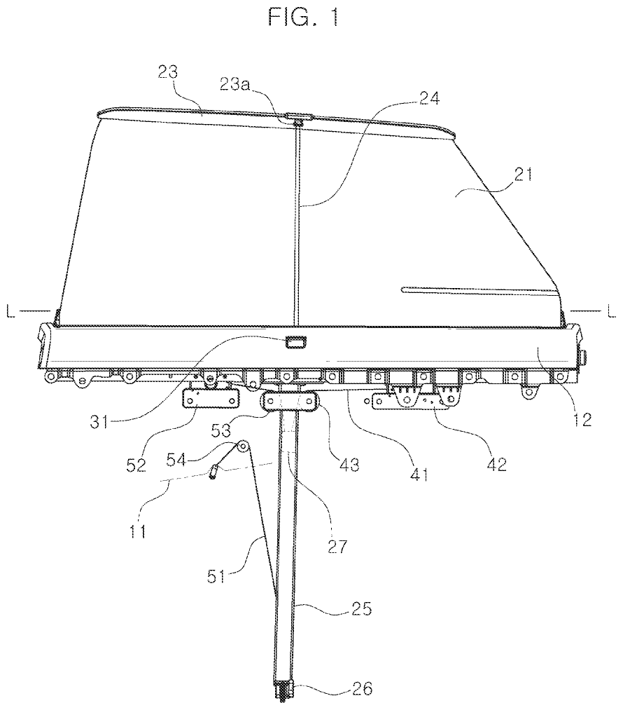

FIG. 2 is an exploded perspective view illustrating the pop-up deploying type door curtain assembly for a vehicle according to an embodiment of the present disclosure.

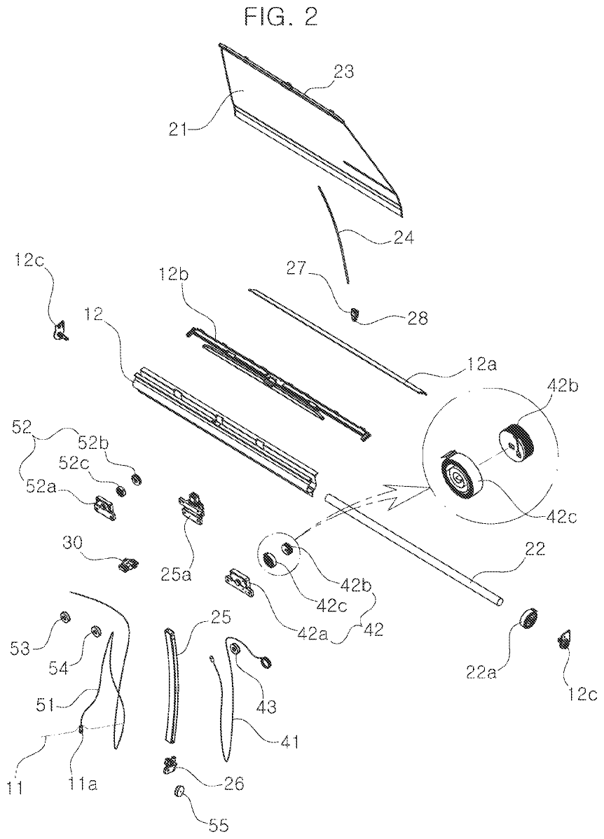

FIG. 3 is a schematic diagram illustrating a state in which a door glass ascends and a curtain is deployed in the pop-up deploying type door curtain assembly for a vehicle according to an embodiment of the present disclosure.

FIG. 4 is a perspective view illustrating a state before a button unit is operated in the pop-up deploying type door curtain assembly for a vehicle according to an embodiment of the present disclosure.

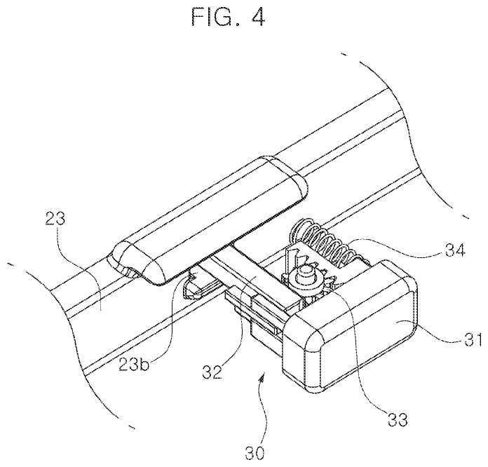

FIG. 5 is a side view illustrating the state before the button unit is operated in the pop-up deploying type door curtain assembly for a vehicle according to an embodiment of the present disclosure.

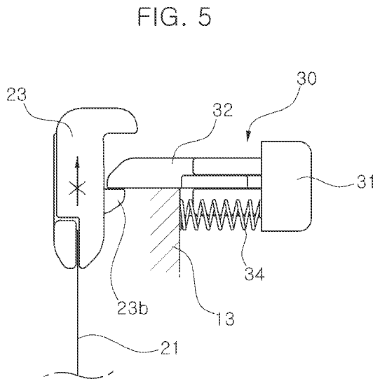

FIG. 6 is a perspective view illustrating a state in which the button unit is operated in the pop-up deploying type door curtain assembly for a vehicle according to an embodiment of the present disclosure.

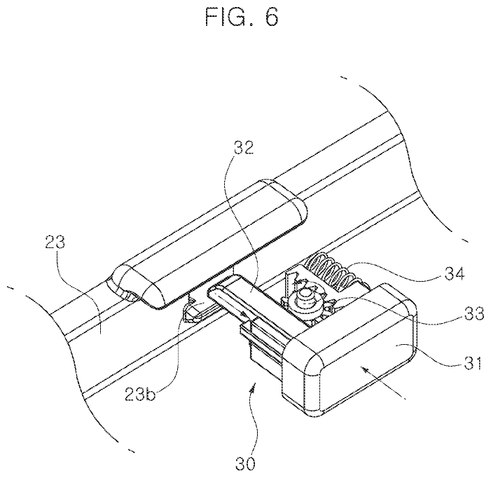

FIG. 7 is a side view illustrating the state in which the button unit is operated in the pop-up deploying type door curtain assembly for a vehicle according to an embodiment of the present disclosure.

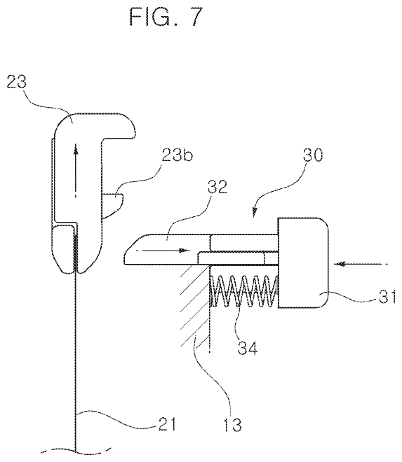

FIG. 8 is a schematic diagram illustrating a state in which a first cable is wound to move a slider upward in the pop-up deploying type door curtain assembly for a vehicle according to an embodiment of the present disclosure.

FIG. 9 is a schematic diagram illustrating a state in which the curtain is deployed in the pop-up deploying type door curtain assembly for a vehicle according to an embodiment of the present disclosure.

FIG. 10 is a schematic diagram illustrating a state in which a second cable is wound around a second drum unit while the slider ascends in the pop-up deploying type door curtain assembly for a vehicle according to an embodiment of the present disclosure.

FIG. 11 is a perspective view illustrating a state in which a slider and a second cable are connected in the pop-up deploying type door curtain assembly for a vehicle according to an embodiment of the present disclosure.

FIG. 12 is a cross-sectional view illustrating a state in which one end portion of the second cable is connected to the door glass in the pop-up deploying type door curtain assembly for a vehicle according to an embodiment of the present disclosure.

FIG. 13 is a schematic diagram illustrating a state in which the curtain is accommodated by an occupant in the pop-up deploying type door curtain assembly for a vehicle according to an embodiment of the present disclosure.

FIG. 14 is a schematic diagram illustrating a state in which the first cable is unwound from a first drum unit when the curtain is accommodated in the pop-up deploying type door curtain assembly for a vehicle according to an embodiment of the present disclosure.

FIG. 15 is a schematic diagram illustrating a relationship between the slider and the second cable when the curtain is accommodated in the pop-up deploying type door curtain assembly for a vehicle according to an embodiment of the present disclosure.

FIG. 16 is a schematic diagram illustrating a descending state of the door glass in the pop-up deploying type door curtain assembly for a vehicle according to an embodiment of the present disclosure.

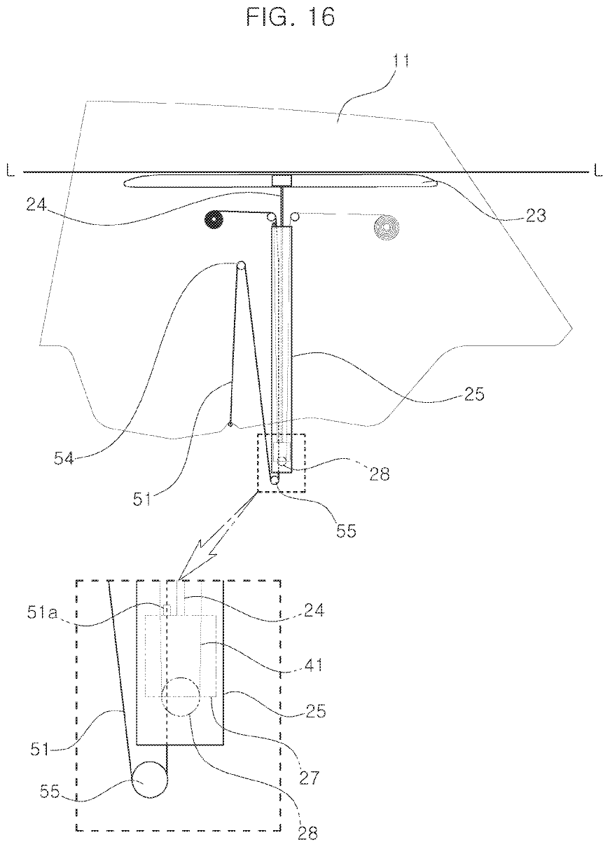

FIG. 17 is a schematic diagram illustrating a state in which the curtain descends in conjunction with a descending operation of the door glass in the pop-up deploying type door curtain assembly for a vehicle according to an embodiment of the present disclosure.

FIG. 18 is a schematic diagram illustrating a state in which the curtain is hindered from ascending in the descending state of the door glass in the pop-up deploying type door curtain assembly for a vehicle according to an embodiment of the present disclosure.

FIG. 19 is a schematic diagram illustrating a state in which the door glass ascends in a state in which the curtain is accommodated in the pop-up deploying type door curtain assembly for a vehicle according to an embodiment of the present disclosure.

### DETAILED DESCRIPTION OF ILLUSTRATIVE EMBODIMENTS

Hereinafter, a pop-up deploying type door curtain assembly for a vehicle according to embodiments of the present disclosure will be described in detail with reference to the accompanying drawings.

The pop-up deploying type door curtain assembly for a vehicle according to the present disclosure includes a curtain 21 deployed to cover a door glass 11 when drawn out from a vehicle door, a rod 24 which is installed to be ascendable and descendable on a door, includes an upper end portion fixed to an upper end portion of the curtain 21, and supports the curtain 21 in a deployed state, a slider 27 fixed to a lower end portion of the rod 24 and configured to ascend integrally with the rod 24, a first drum unit 42 configured to elastically support the slider 27 in an ascending direction to allow the curtain 21 to be deployed, a second drum unit 52 configured to move the slider 27 downward in conjunction with a descending operation of the door glass 11, and a button unit 30 configured to limit a deployment of the curtain 21 when the curtain 21 is accommodated in the door.

The curtain 21 may be made of a fabric or the like and may be accommodated inside the door of a vehicle in a wound state. When the curtain 21 is drawn out from the door during use, the curtain 21 may be deployed adjacent to an inner surface of the door glass 11.

A frame 12 may be installed inside the door. The frame 12 may be formed in a length direction of the vehicle, and the curtain 21 may be accommodated inside the frame 12 in a wound state. The frame 12 may be formed in a tubular structure and may be formed in a state in which an upper surface is incised cut in order to withdraw and accommodate the curtain 21. A cover 12a for covering the incised portion and a guide 12b for guiding the withdrawal and accommodation of the curtain 21 may be provided on the incised upper surface of the frame 12. Both end portions of the frame 12 may be finished by inserting end caps 12c into both end portions thereof.

A shaft 22 may be rotatably installed inside the frame 12. A lower end portion of the curtain 21 may be fixed to the shaft 22. When the curtain 21 is accommodated, the shaft 22 may be rotated, and then the curtain 21 may be wound around the shaft 22 and accommodated. During the withdrawal of the curtain 21, the curtain 21 may be withdrawn to rotate the shaft 22.

A winding spring 22a for elastically supporting the shaft 22 may be installed on one side of the shaft 22 to allow the curtain 21 to be wound around the shaft 22. The winding spring 22a may be formed in the form of a clockwork spring, may be connected to the shaft 22 and the frame 12, and elastically supports the shaft 22 to be rotated in a direction in which the shaft 22 winds the curtain 21. The deployed curtain 21 may be automatically wound around the shaft 22 by the winding spring 22a, and thus the curtain 21 may be accommodated inside the door.

A shade bar 23 may be provided in an upper end portion of the curtain 21. The shade bar 23 may be disposed in the length direction of the vehicle and may be fixed to the upper end portion of the curtain 21 to allow the curtain 21 to be unfolded uniformly when the curtain 21 is deployed.

A knob 23a may be provided on the shade bar 23. An occupant may move the shade bar 23 downward in a state of holding the knob 23a to allow the curtain 21 to be wound around the shaft 22, thereby accommodating the curtain 21. However, since the occupant may directly hold and move the shade bar 23 downward, the knob 23a may be omitted.

In addition, a catch hook 23b caught on a stopper 32, which will be described below, may be formed at the shade bar 23. When the shade bar 23 descends, the catch hook 23b passes through the stopper 32, whereas, when the shade bar 23 ascends, an ascending operation of the catch hook 23b may be limited by the stopper 32.

In a state in which the curtain 21 is accommodated, the shade bar 23 may be positioned below a belt line (line L-L).

The rod 24 may support the shade bar 23 to maintain a deployed state of the curtain 21. In the door curtain assembly of embodiments of the present disclosure, since the shade bar 23 is not fixed to a door frame or a vehicle body, the rod 24 may support the shade bar 23 to maintain the deployed state of the curtain 21. That is, when the curtain 21 is deployed, both of the shade bar 23 and the rod 24 ascend, and when the ascending operation is completed, the rod 24 may support the shade bar 23 to maintain the deployed state of the curtain 21. In this way, since the shade bar 23 is not coupled and fixed to the door frame or the vehicle body, the curtain 21 may be installed on the door regardless of whether the door frame is applied. Therefore, the curtain 21 may be applied even to a frameless type door which cannot fix the shade bar 23. The rod 24 may ascend or descend together with the shade bar 23. In the state in which the curtain 21 is accommodated, the rod 24 may be positioned inside the door, and when the curtain 21 is deployed, the rod 24 may ascend together with the shade bar 23 to be exposed to the outside.

A guide rail 25 may guide the ascending and descending operations of the rod 24. The guide rail 25 may be formed in a hollow tubular structure, and thus the rod 24 and the slider 27 may be installed therein to slide. Alternatively, the slider 27 may be assembled to one side of the guide rail 25 in a slidable state. A lower end portion of the guide rail 25 may be fixed to the door through a fixing bracket 26.

A guide housing 25a for fixing the guide rail 25 to the door may be installed at an upper portion of the guide rail 25, and a cable fixing part 25b to which one end portion of a first cable 41 is fixed may be formed at the guide housing 25a.

The slider 27 may be assembled to the rod 24 and slidably installed on the guide rail 25. The slider 27 may allow the rod 24 to ascend or descend smoothly on an inner surface of the guide rail 25.

A cable slot 27a may be formed at the slider 27 in an ascending and descending direction of the slider 27.

A first pulley 28 may be provided below the slider 27. The first pulley 28 may catch the first cable 41 to change a direction of the first cable 41.

A button unit 30 may be provided on the door, and when the curtain 21 is accommodated in the door, the button unit 30 may limit a deployment of the curtain 21. In addition, when the curtain 21 accommodated in the door is deployed, the button unit 30 may be operated by the occupant.

To this end, the button unit 30 may include a button 31 operated by the occupant and a stopper 32 for limiting the upper end portion of the curtain 21 from ascending. Since the button unit 30 is installed on an upper end portion of a door trim 13, when the curtain 21 is accommodated inside the door, the stopper 32 may limit the upper end portion of the curtain 21 from ascending so that the curtain 21 maintains the accommodated state.

The button 31 and the stopper 32 may be slidably installed in an upper portion of the door trim 13 in a direction perpendicular to an ascending and descending direction of the shade bar 23. The button 31 and the stopper 32 may be coupled to each other and slide in opposite directions. That is, the button 31 and the stopper 32 may be coupled such that, when the button 31 is pressed, the stopper 32 may slide in a direction opposite to the operating direction of the button 31. In order to allow the button 31 and the stopper 32 to slide in opposite directions, a direction change gear 33 may be installed between the button 31 and the stopper 32. The direction change gear 33 may be installed between the button 31 and the stopper 32, and the button 31 and the stopper 32 may be engaged with the direction change gear 33 so that the stopper 32 slides in the direction opposite to the operating direction of the button 31.

The stopper 32 may limit the ascending operation of the catch hook 23b of the shade bar 23 to maintain the curtain 21 in a state of being accommodated in the door. Since a lower surface of the stopper 32 and an upper surface of the catch hook 23b are each formed as a flat surface, when the catch hook 23b is positioned below the stopper 32, the stopper 32 may limit the ascending operation of the catch hook 23b.

Meanwhile, the stopper 32 and the catch hook 23b may be configured such that, when the catch hook 23b is positioned higher than the stopper 32, the catch hook 23b may pass through the stopper 32. To this end, an end portion of the stopper 32 and an end portion of the catch hook 23b each may be formed in a round shape. Thus, when the catch hook 23b descends in a state in which the catch hook 23b is positioned higher than the stopper 32, the catch hook 23b may push the stopper 32 to descend.

A return spring 34 may be installed between the button 31 and the door trim 13. The return spring 34 elastically supports the button 31 in a direction opposite to the direction in which the button 31 is pressed. Thus, the return spring 34 may elastically support the stopper 32 toward the catch hook 23b.

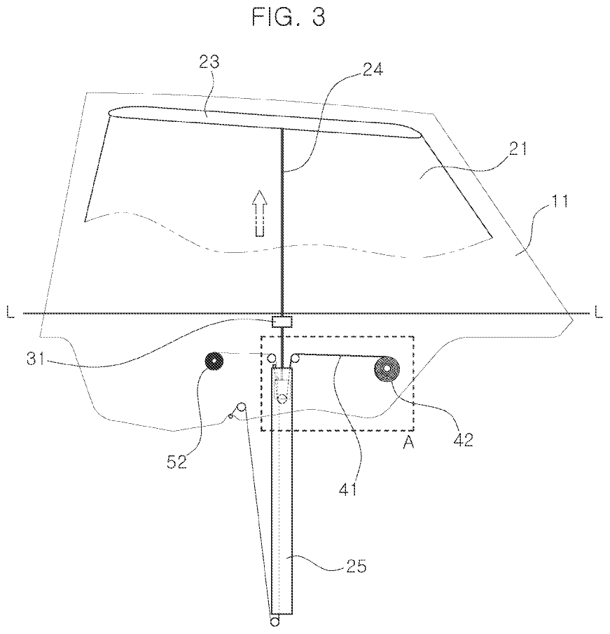

The first drum unit 42 may be installed inside the door to allow the curtain 21 to be deployed using the first cable 41 (see portion A in FIG. 3).

One end portion of the first cable 41 may be fixed to one side of the door, the other end portion thereof may be wound around the first drum unit 42, and an intermediate portion thereof may pass the first pulley 28.

The one end portion of the first cable 41 may be fixed to the upper portion of the guide rail 25 or the guide housing 25a.

The first drum unit 42 may wind the other end portion of the first cable 41 and winds the first cable 41 from the other end portion thereof by a predetermined length.

The first drum unit 42 may include a first case 42a fixed to the door, a first drum 42b which is rotatably installed inside the first case 42a and around which the first cable 41 is wound, and a first cable spring 42c configured to elastically support the first drum 42b in a direction in which the first cable 41 is wound around the first drum 42b.

The first drum 42b and the first cable spring 42c may be rotatably installed inside the first case 42a. The first cable spring 42c may be provided in the form of a clockwork spring, and the first cable spring 42c may elastically support the first drum 42b to allow the first cable 41 to be wound around the first drum 42b. Thus, when the restraint of the shade bar 23 is released from the stopper 32, the first drum unit 42 may wind the first cable 41, a length of the first cable 41 may be shortened, and thus the first pulley 28 ascends. When the first pulley 28 ascends, the slider 27, the rod 24, and the shade bar 23 may ascend, and the curtain 21 may be drawn out from the door.

The first cable 41 may pass the first pulley 28 installed at a lower end portion of the slider 27 and a second pulley 43 installed at one side of the door. Since the first cable 41 passes the first pulley 28, when the first cable 41 is wound around the first drum unit 42 and thus the length of the exposed first cable 41 is shortened, the first pulley 28 may ascend to deploy the curtain 21. The second pulley 43 may serve to change the direction of the first cable 41, which passes the first pulley 28 so that the first cable 41 is wound around the first drum unit 42.

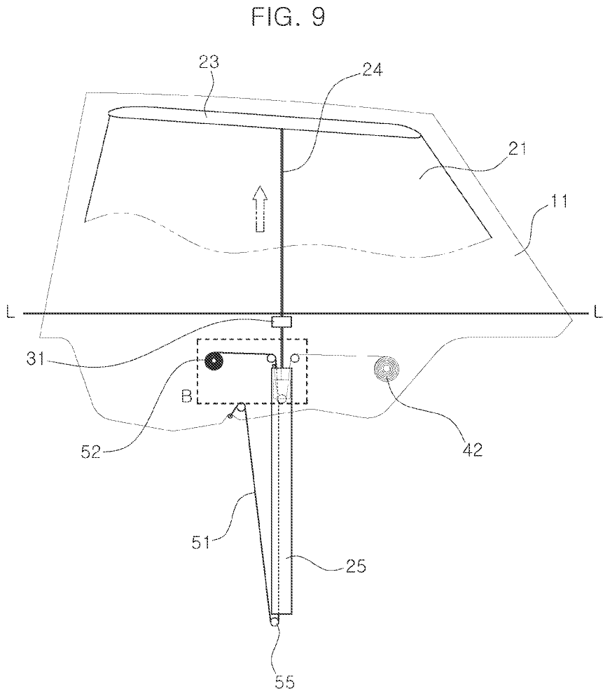

The second drum unit 52 may be installed inside the door to interlock the descending operation of the door glass 11 with the descending operation of the slider 27 using a second cable 51 (see B in FIG. 9). Thus, when the door glass 11 descends, the curtain 21 may be accommodated inside the door.

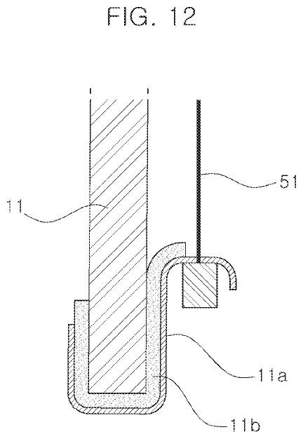

One end portion of the second cable 51 may be connected to a lower portion of the door glass 11. A cable bracket 11a may be fastened to the lower portion of the door glass 11, and the one end portion of the second cable 51 may be connected to the cable bracket 11a (see FIG. 12). Thus, when the door glass 11 descends, the one end portion of the second cable 51 also may descend along the door glass 11. It is preferable that a pad 11b is provided between the door glass 11 and the cable bracket 11a in order to improve assemblability between the door glass 11 and the cable bracket 11a and prevent noise generation. The pad 11b may be made of a non-woven fabric, a foam pad, rubber, or the like.

The second drum unit 52 may allow the second cable 51 to maintain constant tension. The second drum unit 52 may wind the other end portion of the second cable 51 by a predetermined length. Similar to the first drum unit 42, the second drum unit 52 may include a second case 52a fixed to the door, a second drum 52b which is rotatably installed inside the second case 52a and around which the second cable 51 is wound, and a second cable spring 52c configured to elastically support the second drum 52b in a direction in which the second cable 51 is wound around the second drum 52b.

When the door glass 11 ascends, the second cable 51 is wound around the second drum unit 52 so that the second cable 51 may maintain appropriate tension. The second cable 51 may be supported through a third pulley 53, a fourth pulley 54, and a fifth pulley 55, which are provided between the lower portion of the door glass 11 and the second drum unit 52 and, simultaneously, a direction of the second cable 51 may be changed.

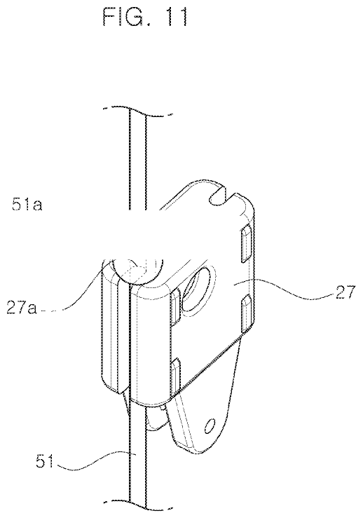

Meanwhile, a catch block 51a may be provided in the middle of the second cable 51 to allow the slider 27 to descend together when the second cable 51 moves due to the descending of the door glass 11. Cable slots 27a may be formed in the slider 27 at separated positions in order to allow the first cable 41 and the second cable 51 to pass through the slider 27. The second cable 51 may be installed to pass through one of the cable slots 27a. The catch block 51a may be formed to have a cross-sectional area that is greater than that of the cable slot 27a and may be installed on the second cable 51 to be positioned above the slider 27 (see FIG. 11). Thus, when the second cable 51 moves downward in a state in which the catch block 51a is positioned on an upper surface of the slider 27, the slider 27 may also move downward. However, when the second cable 51 moves upward, the catch block 51a cannot move the slider 27. In addition, when the slider 27 descends, the catch block 51a may maintain its position and the slider 27 may be spaced apart from the catch block 51a.

An operation of the pop-up deploying type door curtain assembly for a vehicle according to embodiments of the present disclosure, which has the above-described configuration, will be described as follows.

When the occupant operates the button unit 30 in order to deploy the curtain 21, the curtain 21 may be popped up, and the first drum unit 42 may move the shade bar 23 upward so that the curtain 21 is deployed.

When the occupant presses the button 31 of the button unit 30, the stopper 32 may be moved in a direction opposite to the operating direction of the button 31 to be separated from the catch hook 23b. When the stopper 32 is separated from the catch hook 23b, the shade bar 23 may become capable of ascending.

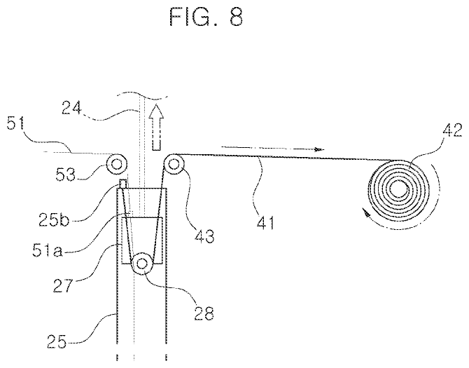

In this case, the curtain 21 may be popped up and deployed by the first cable 41 and the first drum unit 42. Since an elastic force acts in a direction in which the first cable 41 is pulled by the first cable spring 42c, the first cable 41 may move the first pulley 28 upward. When the first pulley 28 ascends, the slider 27, the rod 24, and the shade bar 23 may ascend (see FIG. 8). Since the curtain 21 is connected to the shade bar 23, the curtain 21 may be deployed. That is, when the first cable spring 42c rotates the first drum 42b, the first drum 42b may wind the first cable 41, and thus the length of the exposed first cable 41 may be shortened. Consequently, the first pulley 28 may ascend. When the first pulley 28 ascends, the slider 27, the rod 24, and the shade bar 23 may ascend, and the curtain 21 may be drawn out from the door and deployed.

Since the shade bar 23 is not connected to the door frame or the vehicle body structure and is in a state of being supported by the rod 24, an upper surface of the shade bar 23 may be positioned without a gap between the door frame and a roof of the vehicle so that an area, which is not blocked in an upward direction of the shade bar 23, may disappear, and thus an occlusion amount may be reduced. In addition, since the shade bar 23 is not caught and fixed to the door frame or the roof, the shade bar 23 may be applied to the frameless door without the door frame.

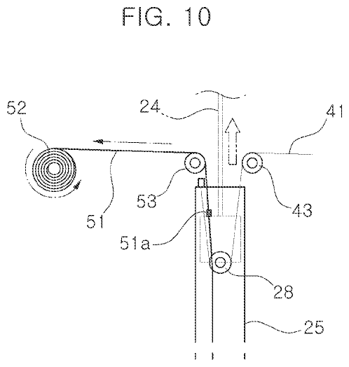

When the curtain 21 is deployed, the second drum unit 52 may wind the second cable 51 to allow the second cable 51 to be taut (see FIG. 10).

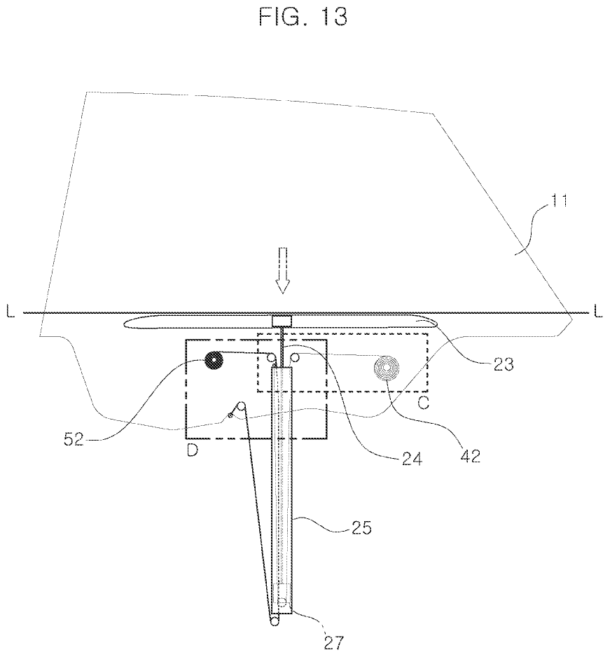

Meanwhile, when the occupant intends to accommodate the curtain 21, and when the shade bar 23 descends using the knob 23a, the curtain 21 may be wound and accommodated inside the door (see FIG. 13). When the knob 23a is not applied, the occupant may directly press the shade bar 23 to move the shade bar 23 downward.

When the occupant holds the knob 23a to move the shade bar 23 downward or directly holds and moves the shade bar 23 downward, the lower end portion of the curtain 21 may be wound around the shaft 22 and accommodated inside the frame 12 in a wound state.

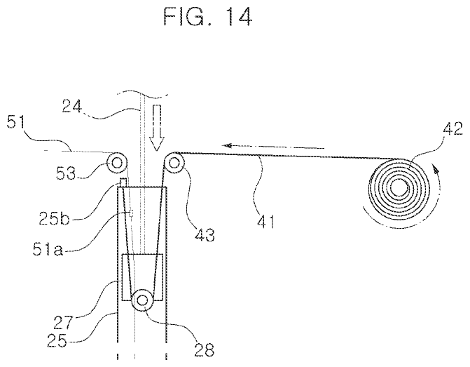

In addition, the rod 24 and the slider 27 may descend together with the shade bar 23. In addition, as the slider 27 descends, the first cable 41 may be released from the first drum unit 42 (see FIG. 14).

When the occupant continues to move the shade bar 23 downward, the catch hook 23b may pass the stopper 32. Since the end portions of the catch hook 23b and the stopper 32 are each formed in a round shape, in a state in which the catch hook 23b is positioned higher than the stopper 32, the catch hook 23b may descend to pass the stopper 32. Then, when the stopper 32 is positioned lower than the catch hook 23b, the stopper 32 may limit the ascending operation of the catch hook 23b. Thus, even when the occupant releases the knob 23a or the shade bar 23, the shade bar 23 may not ascend and the curtain 21 remains in the accommodated state.

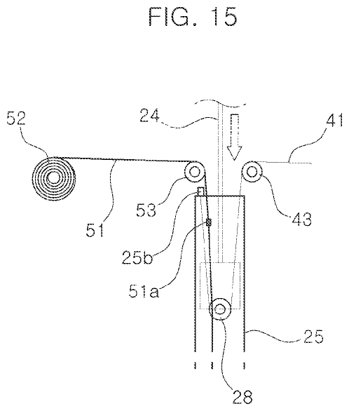

In addition, as described above, when the shade bar 23 descends alone, the second cable 51 may be not released or wound (see FIG. 15). In this case, as the slider 27 descends, the slider 27 may be spaced apart from the catch block 51a.

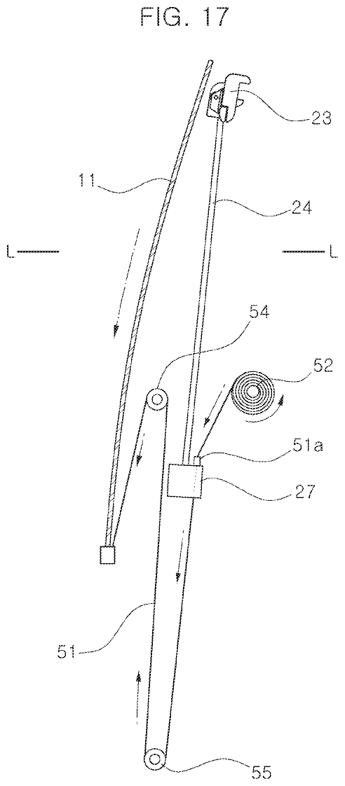

Meanwhile, when the occupant moves the door glass 11 downward in a state in which both of the door glass 11 and the curtain 21 ascend, the curtain 21 may also descend in conjunction with the descending operation of the door glass 11 (see FIG. 17).

As the door glass 11 descends, the door glass 11 may pull one end portion of the second cable 51, and thus the second cable 51 may be released from the second drum unit 52. As the door glass 11 descends, the second cable 51 may move to pass the third pulley 53, the fourth pulley 54, and the fifth pulley 55. In this case, the catch block 51a fixed to the second cable 51 may descend between the third pulley 53 and the fourth pulley 54 to move the slider 27 downward. When the catch block 51a being descended is caught on the upper surface of the slider 27, the slider 27 may be caught on the catch block 51a to descend. When the slider 27 descends, the shade bar 23 and the rod 24 may descend, and the curtain 21 may be wound around the shaft 22 and accommodated.

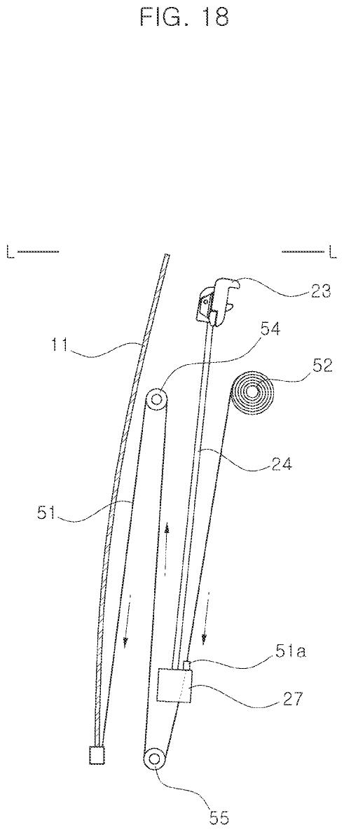

When the door glass 11 continues to descend, the catch hook 23b of the shade bar 23 may pass the stopper 32. Thereafter, when the descending operation of the door glass 11 is completed, since the catch hook 23b is caught to the stopper 32 and is limited from ascending, the curtain 21 may remain in a state of being inserted into the frame 12 (see FIG. 18).

When the slider 27 descends in conjunction with the descending operation of the door glass 11, the first cable 41 may be released from the first drum unit 42 according to the descending operation of the slider 27.

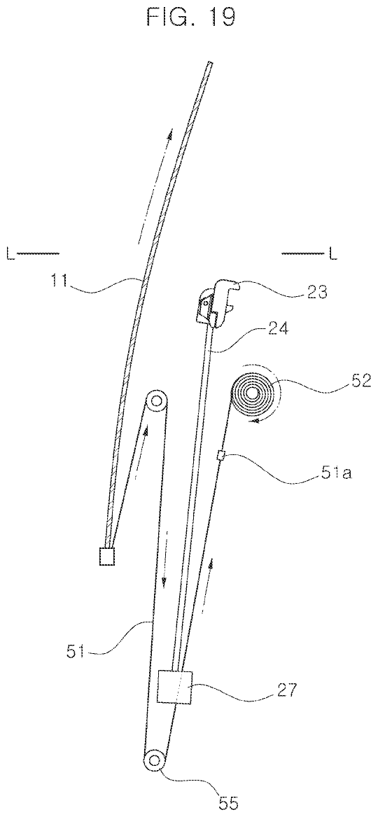

Meanwhile, in a state in which the curtain 21 descends, the door glass 11 ascends regardless of the curtain 21. In the state in which the curtain 21 descends, the catch hook 23b of the shade bar 23 may be caught to the stopper 32, and thus the ascending operation of the catch hook 23b may be limited (see FIG. 19). Consequently, the curtain 21 may not ascend or descend in conjunction with the ascending and descending operations of the door glass 11. However, the second cable 51 may be wound around the second drum unit 52 or released therefrom according to the ascending and descending operations of the door glass 11, but the catch block 51a moves within a range in which the catch block 51a is not caught on the upper surface of the slider 27.

In accordance with a pop-up deploying type door curtain assembly for a vehicle of embodiments of the present disclosure, which has the above-described configuration, since an upper end portion of a curtain is not fixed to a door frame, the curtain may be applied regardless of the presence or absence of the door frame. Thus, a semi-automatic curtain may be applied even to a frameless type door.

The curtain may be manually accommodated by an occupant, whereas, during deployment, the curtain may be automatically deployed by an elastic force of a spring so that the curtain can be used conveniently. In addition, since an electric component for deploying or accommodating the curtain and an electronic component for controlling the electric component are not applied, a structure may be simplified. In addition, production cost can be reduced due to non-application of expensive electric components and electronic components.

While embodiments of the present disclosure have been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

What is claimed is:

1. A pop-up deploying type door curtain assembly for a vehicle, the assembly comprising:
a curtain deployable to cover a door glass when drawn out from a vehicle door;
a rod configured to be installed on the vehicle door to ascend and descend and configured to support the curtain in a deployed state;
a slider fixed to the rod and configured to ascend or descend integrally with the rod;
a first drum apparatus configured to elastically support the slider in an ascending direction in order to allow the curtain to be deployed; and
a button apparatus configured to limit a deployment of the curtain in a state in which the curtain is accommodated in the vehicle door.

2. The assembly of claim 1, further comprising a first cable comprising a first end portion configured to be fixed to one side of the vehicle door, the first cable being configured to elastically support a lower end portion of the slider and to be wound around the first drum apparatus.

3. The assembly of claim 2, wherein the first drum apparatus comprises:
a first drum around which the first cable is configured to be wound; and
a first cable spring configured to elastically support the first drum in a direction in which the first cable is to be wound around the first drum.

4. The assembly of claim 3, further comprising a first pulley at a lower portion of the slider and configured to catch the first cable.

5. The assembly of claim 2, further comprising a guide rail with which the slider is slidably assembled and to which the first end portion of the first cable is fixed.

6. The assembly of claim 1, further comprising a second cable configured to move the curtain downward in conjunction with a descending operation of the door glass.

7. The assembly of claim 6, further comprising a second drum apparatus configured to move the slider downward in conjunction with the descending operation of the door glass.

8. The assembly of claim 7, wherein a first end portion of the second cable is connected to a lower portion of the door glass, a predetermined length of the second cable from a second end portion of the second cable is configured to be wound around the second drum apparatus, and an intermediate portion of the second cable is connected to a catch block fixed to the slider.

9. The assembly of claim 8, wherein:
a cable slot through which the second cable passes is provided in the slider;
the catch block is fixed to the second cable to be positioned above the slider; and
in a state in which the door glass descends, the catch block is configured to descend to move the slider downward.

10. The assembly of claim 8, wherein the second drum apparatus includes:
a second drum around which the second cable is configured to be wound; and
a second cable spring configured to elastically support the second drum in a direction in which the second cable is to be wound around the second drum.

11. The assembly of claim 8, further comprising a cable bracket fastened to the lower portion of the door glass, wherein the second cable is connected to the cable bracket.

12. The assembly of claim 8, further comprising a plurality of pulleys between the lower portion of the door glass and the second drum apparatus configured to catch the second cable so that, in a state in which the door glass descends, the second cable is configured to move to move the catch block downward.

13. A pop-up deploying type door curtain assembly for a vehicle, the assembly comprising:
a curtain deployable to cover a door glass when drawn out from a vehicle door;
a rod configured to be installed on the vehicle door to ascend and descend and configured to support the curtain in a deployed state;
a slider fixed to the rod and configured to ascend or descend integrally with the rod;
a first drum apparatus configured to elastically support the slider in an ascending direction in order to allow the curtain to be deployed; and
a button apparatus configured to limit a deployment of the curtain in a state in which the curtain is accommodated in the vehicle door, wherein the button apparatus comprises:
a button operable by an occupant; and
a stopper configured to limit an ascending operation of an upper end portion of the curtain, wherein, in a state in which the button is operated by the occupant, the stopper is configured to separate from the upper end portion of the curtain.

14. The assembly of claim 13, wherein:
the button and the stopper are slidingly coupled; and
a direction change gear configured to slide the stopper in a direction opposite to an operating direction of the button is installed between the button and the stopper.

15. The assembly of claim 13, further comprising a return spring configured to elastically support the button in order to return the operated button to its previous state.

16. The assembly of claim 13, further comprising:
a shade bar installed at the upper end portion of the curtain in a length direction of the vehicle; and
a catch hook disposed at the shade bar and configured to be caught and fixed to the stopper.

17. The assembly of claim 16, wherein a lower surface of the stopper and an upper surface of the catch hook are each provided in a flat surface to limit an ascending operation of the catch hook.

18. The assembly of claim 17, wherein an end portion of the stopper and the catch hook each have a round shape to allow the catch hook to descend.

19. A vehicle comprising:
a vehicle door;
a door glass disposed in the vehicle door; and
a pop-up deploying type door curtain assembly comprising:
a curtain deployable to cover the door glass when drawn out from the vehicle door;
a rod installed on the vehicle door to ascend and descend and configured to support the curtain in a deployed state;
a slider fixed to the rod and configured to ascend or descend integrally with the rod;
a first drum apparatus configured to elastically support the slider in an ascending direction in order to allow the curtain to be deployed;
a button apparatus configured to limit a deployment of the curtain in a state in which the curtain is accommodated in the vehicle door;
a first cable comprising a first end portion fixed to one side of the vehicle door, wherein the first cable is configured to elastically support a lower end portion of the slider and to be wound around the first drum apparatus; and
a second cable configured to move the curtain downward in conjunction with a descending operation of the door glass.

20. The vehicle of claim 19, further comprising a second drum apparatus configured to move the slider downward in conjunction with the descending operation of the door glass, wherein a first end portion of the second cable is connected to a lower portion of the door glass, a predetermined length of the second cable from a second end portion of the second cable is configured to be wound around the second drum apparatus, and an intermediate portion of the second cable is connected to a catch block fixed to the slider.
